(19) United States
(12) Patent Application Publication
(10) Pub. No.: US 2005/0253408 A1
(43) Pub. Date: Nov. 17, 2005

(54) Seat component to prevent whiplash injury

(75) Inventors: Markus Muser, Waedenswil (CH); Kai-Uwe Schmitt, Zuerich (CH)

Correspondence Address: JOYCE VON NATZMER, 4615 NORTH PARK AVENUE, SUITE 919, CHEVY CHASE, MD, 20815, US

(73) Assignee: University of Zuerich, Zuerich (CH)

(21) Appl. No.: 10/518,511

(22) PCT Filed: Jun. 24, 2003
(86) PCT No.: PCT/EP03/06615

§ 371 Date: Dec. 21, 2004

(51) Int. Cl. B60N 2/02

(52) U.S. Cl. 296/68.1

(57) ABSTRACT

A seat component to prevent whiplash injury during a rapid motion change of a vehicle comprises means allowing a displacement of the seat and a person sitting thereon backwards (22) in relation to the direction of movement at the motion change. These means comprise a body (11, 18) to be affixed to or being part of the seat, a slide element (16) affixed to the vehicle and being in guiding contact with said body to guide a translational displacement of the seat over a predetermined distance. It further comprises a trigger system (13) to detect a acceleration threshold, a release mechanism (14) controlled through the trigger system (13) to enable said translational displacement (22) and a damping component (17) to damp said translational displacement (22). The trigger system (13) opens the release mechanism (14) only upon detection of an acceleration value above a predetermined threshold. The NIC experienced when using a conventional seat can be reduced by 40% if said seat is equipped with the device according to the invention.

This invention relates to a seat component to prevent whiplash injury and especially a damping seat component.

### TECHNICAL BACKGROUND

Soft tissue neck injuries sustained in low speed collisions are of continued concern in road traffic. Such injuries—often also called “whiplash injuries”—are particularly observed in rear-end collisions, i.e. if, for example, a car is struck from behind and thus subjected to a forward acceleration. At present, the exact injury mechanisms that cause such injury are still unknown. A number of hypotheses on the nature and location of the injury have been proposed by various researchers. To date, it is widely agreed that a relative motion between the head and the neck, the so-called S-shape deformation, is related to the injurious event. Therefore, to prevent such a deformation, the relative acceleration of the occupants head and torso has to be minimized.

Correspondingly, a number of injury criteria have been evaluated that would allow to predict injuries in low speed impacts. Different approaches developing head restraint systems, seat backs and according recliner joints are also presented.

One particular embodiment according to the prior art can be found in GB 2,359,482. This document relates to a rearward tipping peat to prevent whiplash in collisions. In case of an impact the seat is tipping backwards to allow a rotational movement of the seat back to reduce the distance between the head of a person sitting in the seat to the seat back over a longer distance and time. However, the tipping movement is a disadvantage, because the feet might loose contact with the pedals. Thus the driver might loose control over the vehicle. The head restraint rotates far backwards and therefore reduces the space available for backseat passengers. The same holds true for the overall backwards movement of the seat base. Furthermore, the seat can no longer be adjusted properly after impact, i.e. the seat base is permanently rotated. Depending on the physique of the driver, driving might be impossible with the seat completely out of position. The system might be released by the occupant himself/herself by pushing strongly into the seat (e.g. at an emergency breaking or when placing the feet on the dashboard). Likewise backseat passengers might pull on the seat back and thus release the system. In essence, the system can be released unintentionally.

A further device for avoiding whiplash injuries is known from Nilsson in U.S. 2001/0011830 A1 equally using a tipping movement having the same disadvantageous as explained above. The device requires additional rollers. However, rollers are associated with friction and it can not be guaranteed that the rollers will reliably work after a long period of time when the device was not needed. The friction coefficient might have changed dramatically due to external influences (e.g. dust) and due to slight deformation of the seat structure in daily use. The device according to this document brings the seat in its final position and it can not be adjusted properly anymore. The horizontal distance needed for the backwards motion and rotation is quite large and this is especially crucial if the seat is initially already in the most backwards position as it will be the case with a tall driver.

### SUMMARY OF THE INVENTION

The object of the invention is, inter alia, to provide an improved seat component to prevent whiplash injury.

The seat component to prevent whiplash injury according to the invention is characterized through the features of claim 1.

In order to prevent the relative acceleration of the head and the torso of an occupant sitting in a standard car seat during a rear-end impact, the device allows a translational motion of the seat base relative to the car while damping this motion. The device is mounted between the seat base and the car floor and can therefore be considered as an integral part of the seat.

It consists of an damping mechanism which is triggered by a sensor. The sensor is meant to detect the acceleration and when a certain limit is extended the damping device is released. Additionally, the damping device requires a tripping energy threshold to be extended in order to actively reduce the loading of the occupant. Thus, as a measure to prevent unintended activation, the system needs a certain acceleration followed by an impact force.

Once the system is activated, the seat is allowed to move backwards in a pure translational manner while the motion is damped.

The seat component to prevent whiplash injury according to the invention comprises a number of advantages:
pure translational backwards motion, hence no rotation of the seat base and feet and knees are not lifted, i.e. contact to the pedals (for driver) is preserved Additionally the pure translational backwards motion also ensures that the head restraint does not, as in a rotational motion, move away from the head.
damping elements on both sides of the slide ensure a symmetrical behavior, i.e. symmetrical loading of the occupant.
the seat can be adjusted translationally after impact by means of the normal adjustment which is not damaged during the impact.
the seat remains stable after impact due to the fact that the deformable elements are deformed plastically, i.e. the seat is not loose or bouncing.
the vehicle can still be driven after impact, immediate visit of a service station is not mandatory although recommended.
low repair costs, because only the deformable elements have to be replaced.
the device consists of a trigger system for acceleration and threshold force requirement for damping, i.e. misuse is prevented. Applying force but no acceleration (e.g. pushing into the seat) or applying acceleration but no force will not lead to a release of the system.
only a small distance is needed for effective backwards movement (approx. 40 mm). Hence after impact there is enough space for backseat passengers preserved even in the case that a tall driver uses the most backward position of the seat.

Further preferred embodiments are disclosed in the dependent claims.

### SHORT DESCRIPTION OF THE DRAWINGS

The invention will be explained in greater detail by reference to an exemplary embodiment of the invention shown in figures. Here:

FIG. 1 shows a diagrammatic view of a seat with a seat component in accordance with the invention mounted in a vehicle in its initial position

FIG. 2 shows a diagrammatic view of the seat of FIG. 1 in its final position after an impact,

FIG. 3 shows a perspective view from below of the seat component according to one embodiment of the invention,

FIG. 4 shows the perspective view of FIG. 3 in another angle and a trigger-system without cover,

FIG. 5 shows a first embodiment of a deformable element in its initial position,

FIG. 6 shows the deformable element of FIG. 5 in its final position after having absorbed impact energy,

FIG. 7 shows a second embodiment of a deformable element in its initial position,

FIG. 8 shows the deformable element of FIG. 7 in its final position after having absorbed impact energy,

FIG. 9 shows a diagram of the NIC (neck injury criterion) according to sled tests experiments,

FIG. 10 shows a diagram of the deformation of the deformable element according to said experiments, and

FIG. 11 shows a diagram of the acceleration of the pelvis of a dummy according to said experiments.

### DETAILED DESCRIPTION OF AN EMBODIMENT OF THE INVENTION

FIG. 1 shows a diagrammatic view of a seat 1 in accordance with the invention mounted in a vehicle 2 in its initial position. The seat 1 of the vehicle 2 is mounted to a seat slide 3 which itself is mounted on a rail 4 of the car body 5.

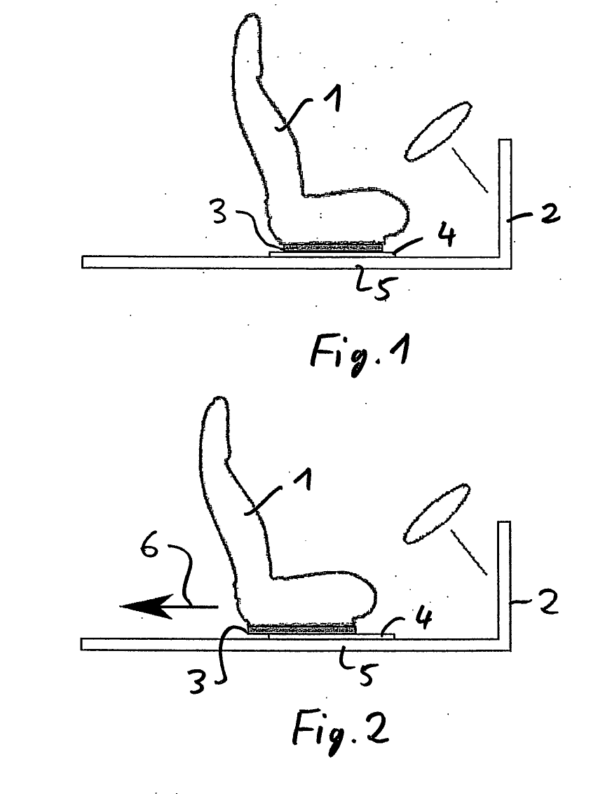

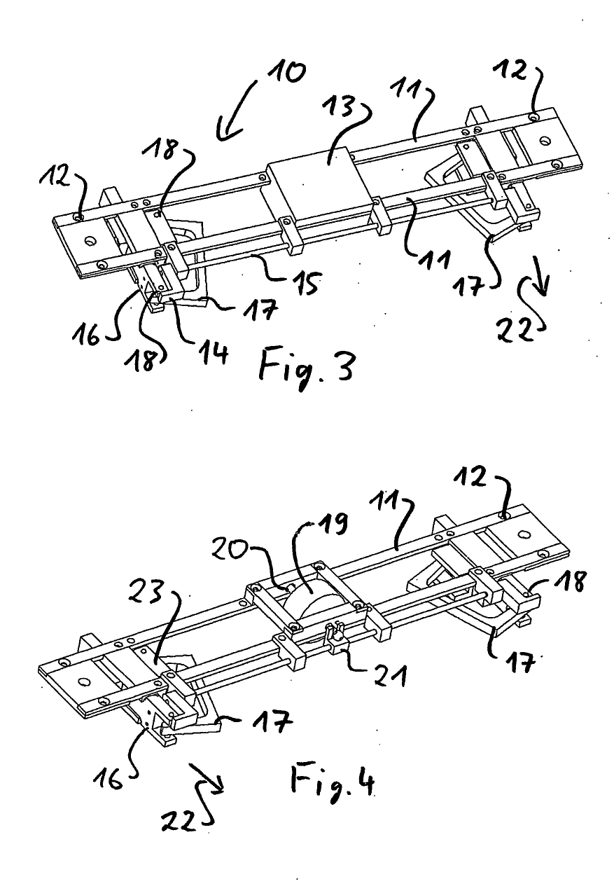

FIG. 2 shows a diagrammatic view of the seat 1 of FIG. 1 after an impact, i.e. in its final position. In case of a rear-end impact, a trigger system which is shown in FIG. 3, releases the seat slide 3 which then enables the seat 1 to move backwards in direction of the arrow 6 (relatively to the vehicle 2) while damping this translational movement.

FIG. 3 shows a perspective view from below of the seat component 10 according to one embodiment of the invention. The seat component 10 is mounted below the seat. The traverses 11 are fixed to the seat itself at different points 12. The traverses 11 may also be part of the seat itself. To ensure that the seat slide 3 moves symmetrical, the seat component 10 is attached to both sides of the seat slide 3. In the embodiment as shown in FIG. 3 both sides of the seat slide 3 are connected by the traverses 11. These traverses 11 are also used to mount the trigger system 13.

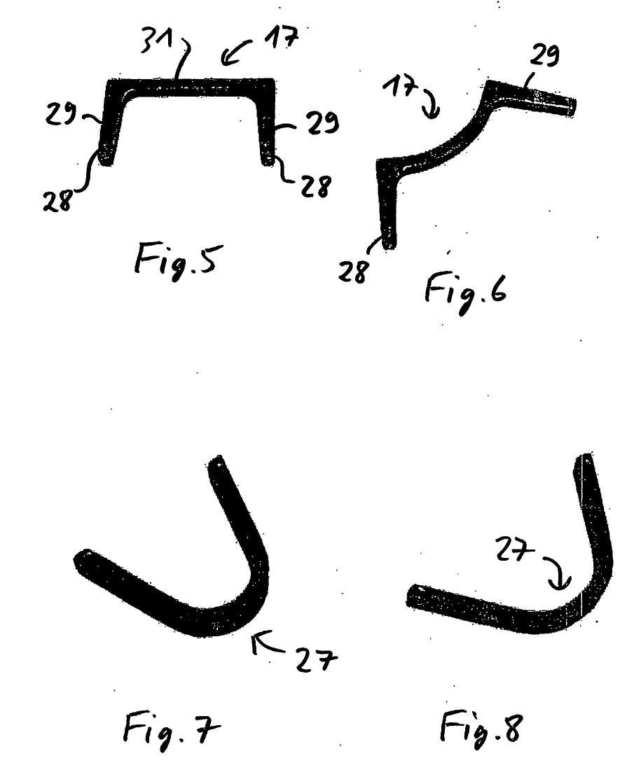

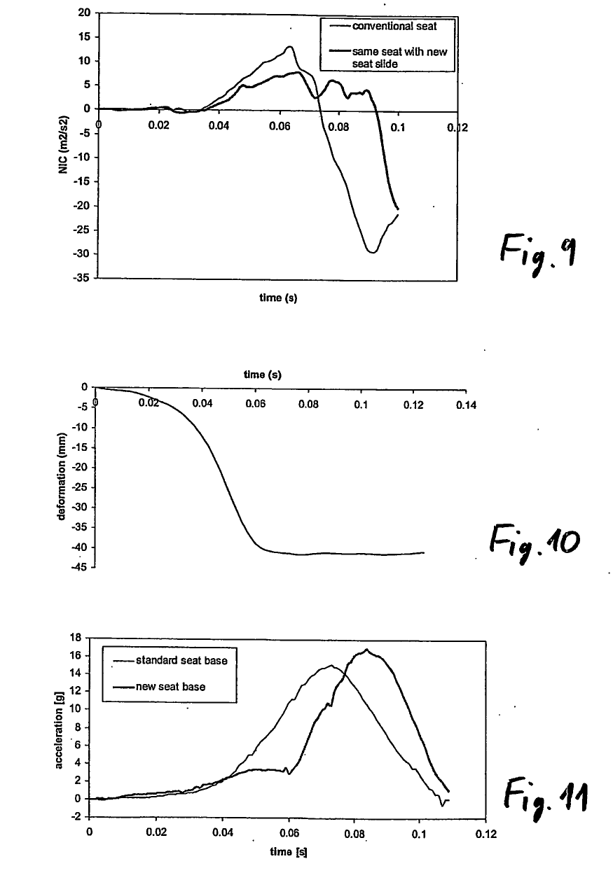

This trigger system 13 transmits the enabling signal to the release mechanism 14. In the case of FIGS. 3 and 4 a rod 15 communicates a mechanical signal to the release mechanism 14. In other embodiments this signal may be an electric signal and the release mechanism 14 is triggered electrically.

Furthermore the trigger system 13 may comprise a system that receives the trigger signal either from an external sensor (e.g. a sensor used in other devices like, for instance, an airbag) or it generates the signal itself utilizing an accelerometer.

The release mechanism 14 in turn frees the slide 16 which upon the impact thus moves backwards. To damp this translational movement the embodiment according to the FIGS. 3 and 4 incorporates a deformable element 17 on each side which can deform plastically. The deformable element 17 is mounted pivotally around pins 18. In other embodiments the deformable element 17 may be fixed to the slide 16 and the traverse 11. However, it is preferred to provide an easy replaceable deformable element 17.

FIG. 4 shows the perspective view of FIG. 3 in another angle and a trigger-system 13 without cover. A mass 19 is provided on a shaft 20 allowing a translational movement of the mass 19 freeing the engagement; element 21 of the rod 15 and thus releasing the deformable element 17. Within this mechanical trigger system a mass-spring-system is used to detect the acceleration level. If the system is accelerated, the mass 19 moves-backwards; This motion is transmitted to the release mechanism 14 which then enables the functioning of the device.

FIG. 4 shows the slide 16 which can move in the direction of the arrow 22. This movement deforms the deformable element 17 being pivotally attached with ping 18 with the slide 16 and the traverse parts 23. The deformable element 17 represents the damping component.

FIG. 5 shows a first embodiment of a deformable element 17 in its initial position, whereas FIG. 6 shows the same deformable element 17 in its final position after having absorbed impact energy. FIG. 7 shows a second embodiment of a deformable element 27 in its initial position, whereas FIG. 8 shows the same deformable element 27 in its final position after having absorbed impact energy.

A constant force-deformation characteristic is aimed at for the deformable element 17. Preferably the element shows a small elastic range followed by a large plateau region until eventually a hardening effect is observed. The distance of the backwards movement which results from the deformation has to be as small as e.g. 40 Millimeters. FIGS. 5 and 7 show two possible out of a multitude of possible element shapes:

FIG. 5 shows a undeformed U-shaped steel profile 17 and FIG. 6 shows the same profile 17 deformed, i.e. after impact.

FIG. 7 shows a undeformed V-shaped steel profile 27 and FIG. 8 shows the same profile 27 deformed, i.e. after impact. Both embodiments (profiles 17 or 27) have a middle part 31 leading to free ends 29. At each of the free ends 29 one bolting point 28 is provided to fix the deformable elements to the seat 1 at the traverse element 23 and to the slide element 16.

The deformable steel elements 17 or 27 of FIGS. 5 and 7 are U-shaped (semi-hollow) profiles of 5 Millimeter thickness. The long side of the part 31 of the profile 17 in FIG. 5 is approx. 8 centimeters whereas the free ends 29 have a length of approx. 4 centimeters. In case of the profile 27 the free ends 29 have a length of approx. 7 centimeters and the transitional rounded part comprises a width of approx. 4 centimeters. These measures are given for the embodiment shown. They have to be adapted if a different displacement is sought.

Beside said steel elements 17 and 27 other elements can be provided as damping component. It is important that these elements have a force-deformation characteristic which is responsible for changes of the acceleration sustained by the person in the seat 1. When using damping elements with other shapes, it has to be noted that these elements work together with the seat slide 16 which guarantees a displacement with only one degree of freedom. Furthermore energy absorber could also be used. Instead of a separate element, a deformable slide is equally conceivable.

FIG. 9 shows a diagram of the NIC (neck injury criterion) according to sled tests experiments and FIG. 10 shows a diagram of the deformation of the deformable element according to said experiments. The results were obtained from sled tests experiments performed according to the proposal for ISO/TC22 N2071, ISO/TC22/SC10 collision test procedures, i.e. a crash pulse with approx. 60 m2/s2 (=6 g) mean acceleration resulting in a velocity change (delta-v) of 15 km/h was used. The person in the seat was a dummy of the BioRID type. Incorporating the device into the seat slide of a conventional state-of-the-art vehicle seat clearly demonstrated the benefits of the new device. According injury criteria like the neck injury criteria (NIC) were reduced by approx. 40% for the new seat slide compared to the standard seat not equipped with the device according to the invention. To achieve such improvement a backwards movement of 40 mm proved to be sufficient as can be seen from FIG. 10.

The device according to the invention was incorporated into a standard car seat having a mechanical sensor as shown in FIGS. 3 and 4. A spring-mass system 13, 19, 20, 21 was used to detect the acceleration necessary to activate the system. If the acceleration threshold is reached the system is released through elements 14 and 15, i.e. a translational motion of the seat 1 relative to the vehicle floor is allowed. In such a case the seat 1 slides along a defined path as a gliding part and is guided along a slide. However, the energy absorbing unit 17, 27 which ensures a constant force restriction is mounted in parallel with the gliding part such that energy must be dissipated in order to allow movement. The energy absorption is performed by deformation of a steel profile 17 or 27, e.g. as shown in FIGS. 5 and 7, respectively. It has to be noted that due to the profile used, a certain elastic force limit must be exceeded to start the energy absorption.

The results show that—upon acceleration of the slide—the dummy moves in direction of the back seat until the movement of the seat slide 16 was triggered. After the end of the movement of the seat slide 16 the head of the dummy comes into contact of the head restraint. The seat back rotates in a backward direction.

In order to avoid whiplash injuries the relative potion between head and neck has to be minimized. The neck injury criterion (NIC) takes into account the relative acceleration of head and body. The experiments show that the maximum value of the NIC was reduced from 13.4 m2/s2 (original seat) to 8.1 m2/s2 (a sweat of the type of the first experiment with the seat components according to the invention). This is a reduction by about 40%.

FIG. 11 shows a diagram of the acceleration of the pelvis of a dummy according to said experiments. It can be seen from said acceleration of the pelvis that the value of the acceleration can be maintained on a plateau of about 3 g during the deformation period of the element 17, 27. The deferment of the pelvis acceleration the acceleration of the thorax is also changed and this reduces the relative acceleration between head and neck, finally resulting in a smaller NIC value.

Alternative embodiments are conceivable, especially it is possible to provide additionally a pivoting movement of the seat at the end of movement although this is not preferred as explained above.

1. A seat component to prevent whiplash injury during a rapid motion change of a vehicle comprising
device(s) allowing a displacement of a seat and a person sitting thereon backwards in relation to a direction of movement at a motion change, wherein said device(s) comprise
a body to be affixed to or being part of the seat,
a slide element affixed to the vehicle and being in guiding contact with said body to guide a translational displacement of the seat over a predetermined distance, and further comprise
a trigger system to detect an acceleration threshold,
a release mechanism controlled through the trigger system to enable said translational displacement,
a damping component to damp said translational displacement,
wherein the trigger system opens the release mechanism upon detection of an acceleration value above a predetermined threshold.

2. The seat component according to claim 1, wherein the trigger system (a) is mounted with the body to detect an acceleration threshold and (b) comprises a mass-spring system.

3. The seat component according to claim 1, wherein the trigger system comprises an accelerometer.

4. The seat component according to claim 1, wherein the trigger system uses an acceleration signal from an external accelerometer.

5. The seat component according to claim 1, wherein the release mechanism comprises a mechanical stop or lever.

6. The seat component according to claim 1, wherein the damping component is a metal profile with two free ends which are attached to the body and the slide element.

7. The seat component according to claim 6, wherein the free ends are pivotally mounted to the body and the slide element through pins.

8. The seat component according to claim 2, wherein the release mechanism comprises a mechanical stop or lever.

9. The seat component according to claim 2, wherein the damping component is a metal profile with two free ends which are attached to the body and the slide element.

10. The seat component according to claim 9, wherein the free ends are pivotally mounted to the body and the slide element through pins.

11. The seat component according to claim 3, wherein the release mechanism comprises a mechanical stop or lever.

12. The seat component according to claim 3, wherein the damping component is a metal profile with two free ends which are attached to the body and the slide element.

13. The seat component according to claim 12, wherein the free ends are pivotally mounted to the body and the slide element through pins.

14. The seat component according to claim 4, wherein the release mechanism comprises a mechanical stop or lever.

15. The seat component according to claim 4, wherein the damping component is a metal profile with two free ends which are attached to the body and the slide element.

16. The seat component according to claim 15, wherein the free ends are pivotally mounted to the body and the slide element through pins.

17. The seat component according to claim 5, wherein the damping component is a metal profile with two free ends which are attached to the body and the slide element.

18. The seat component according to claim 17, wherein the free ends are pivotally mounted to the body and the slide element through pins.
